(19) United States
(12) Patent Application Publication
(10) Pub. No.: US 2016/0129658 A1
(43) Pub. Date: May 12, 2016

(54) METHOD FOR MANUFACTURING A PAPER CONTAINER HAVING A FOAMABLE LAYER

(71) Applicants: CHIEN-BIN CHANG, Taichung City (TW); SHIH-HSUN CHANG, Taichung City (TW)

(72) Inventors: CHIEN-BIN CHANG, Taichung City (TW); SHIH-HSUN CHANG, Taichung City (TW)

(21) Appl. No.: 14/932,703

(22) Filed: Nov. 4, 2015

(30) Foreign Application Priority Data
Nov. 7, 2014 (TW) 103138722

(51) Int. Cl. B31C 3/02; B31D 5/00; B31B 43/00

(52) U.S. Cl. CPC B31C 3/02; B31B 43/00; B31D 5/0086

(57) ABSTRACT

A method for manufacturing a paper container having a foamable layer is provided. A sheet material has opposing first and second faces and a paper layer. An insulating layer is at least partially coated on the first face to form a paper container substrate, and the insulating layer at least includes a foamable layer including a waterborne acrylic resin part, foam powder and a waterborne additive part. The foam powder is evenly distributed in an insulating substrate form by the waterborne acrylic resin part and the waterborne additive part. The paper container substrate is manufactured into the paper container including a body portion and a bottom board. The insulating layer is located on an outer circumferential face of the body portion.

### BACKGROUND OF THE INVENTION

1. Field of the Invention

The present invention relates to a method for manufacturing a container, and more particularly to a method for manufacturing a paper container having a foamable layer.

2. Description of the Prior Art

Usually, people serving in the catering industry use disposable containers to contain food or beverage. Although the disposable containers made of plastic or

Styrofoam are cheap, the disposable containers are not recyclable. To protect the environment, the containers made of plastic or Styrofoam are mostly replaced by paper containers. However, the paper containers has poor insulation effect, so when a user uses the paper container to contain food in a high temperature, s/he may be scalded. To improve the insulation effect, some paper containers (for example, a coffee cup) are surroundingly provided with an insulating ring, and the insulating ring is made of corrugated paper. Although the insulating ring insulates heat effectively, it is inconvenient that the user needs to arrange the insulating ring additionally and that the insulating ring falls off easily. Therefore, a foamed container is provided, a layer of insulating layer is spread on a surface of the foamed container, the insulating layer is processed through a high temperature and high pressure to foam to form a foamed layer, and the insulating layer having the foamed layer provides preferable insulating effect; therefore, with the insulating layer of the container, the user can be prevented from being scalded because of holding the containers containing hot beverage or hot food.

However, in this type of prior art, during a process of manufacturing the foamed container, a foaming temperature of the foamed layer is over 100 degrees Celsius, so the insulating layer needs to be heated additionally to foam the foamed layer smoothly. Therefore, it is energy-consuming to manufacture this type of foamed container, and the price of the foamed container rises as the manufacturing cost increases.

The present invention has arisen to mitigate and/or obviate the afore-described disadvantages.

### SUMMARY OF THE INVENTION

The major object of the present invention is to provide a method for manufacturing a paper container having a foamable layer. A paper container is manufactured through the method for manufacturing the paper container having the foamable layer, and a foaming temperature of the paper container is low; therefore, the paper container does not need to be heated to foam. When the paper container contains a food or a liquid in a high temperature, the foamable layer is heated and begins to foam. After the foamable layer is foamed, the paper container has an insulating effect. Compared with the prior arts, the present invention is cost-saving and time-saving.

To achieve the above and other objects, a method for manufacturing a paper container having a foamable layer is provided, including following steps of: (a) providing a sheet material, the sheet material has a first face and a second face opposite to the first face, and the sheet material at least includes a paper layer. (b) coating an insulating layer at least partially on the first face through screen printing to form a paper container substrate, the insulating layer at least includes a foamable layer, the foamable layer includes a waterborne acrylic resin part, foam powder and a waterborne additive part, the waterborne acrylic resin part and the waterborne additive part integrally form an insulating substrate, the foam powder is evenly distributed in the insulating substrate, and the foamable layer has a foaming temperature. (c) manufacturing the paper container substrate into the paper container, the paper container includes a body portion and a bottom board arranged at a bottom end of the body portion, the bottom board and the body portion define an accommodation space and an opening communicating with the accommodation space, the second face faces toward the accommodation space, and the insulating layer is located on an outer circumferential face of the body portion.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a flow chart showing steps of a first embodiment of the present invention;

FIG. 2 is a breakdown view of the first embodiment of the present invention;

FIG. 3 is another breakdown view of the first embodiment of the present invention;

FIG. 4 is a perspective view of the first embodiment of the present invention;

FIG. 5 is a cross-sectional view of the first embodiment of the present invention;

FIG. 6 is a drawing showing the first embodiment of the present invention foaming;

FIG. 7 is a cross-sectional view of a second embodiment of the present invention;

FIG. 8 is a drawing showing the second embodiment of the present invention foaming;

FIG. 9 is a cross-sectional view of a third embodiment of the present invention;

FIG. 10 is a cross-sectional view of a fourth embodiment of the present invention; and

FIG. 11 is a cross-sectional view of a fifth embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

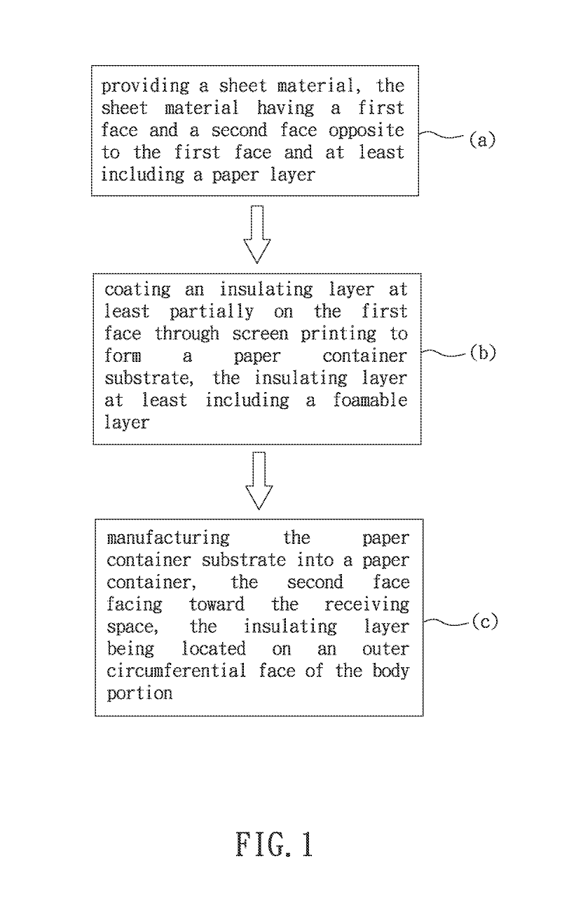

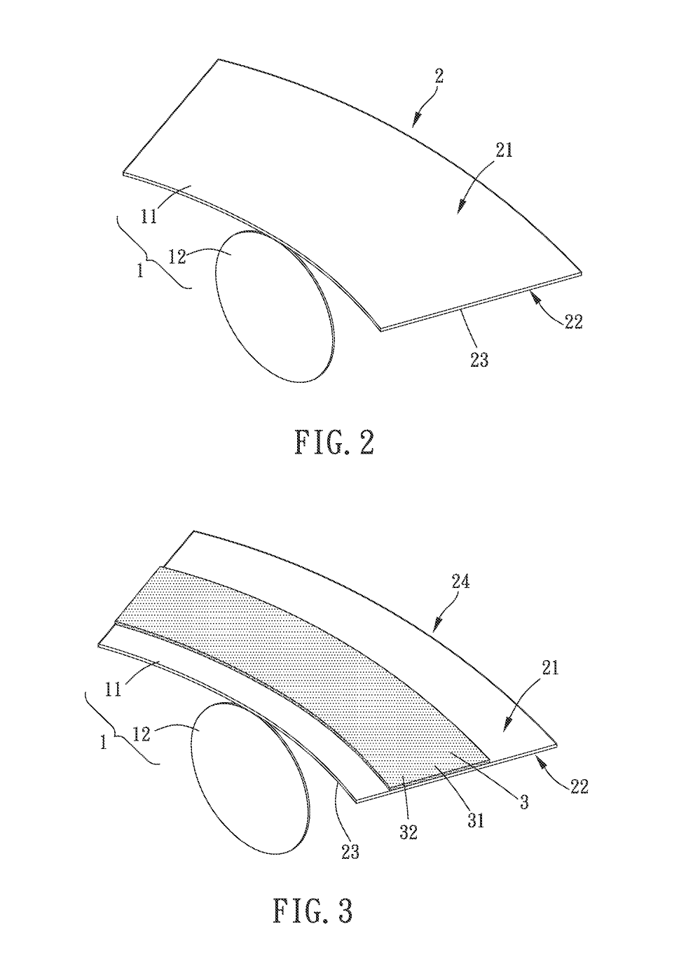

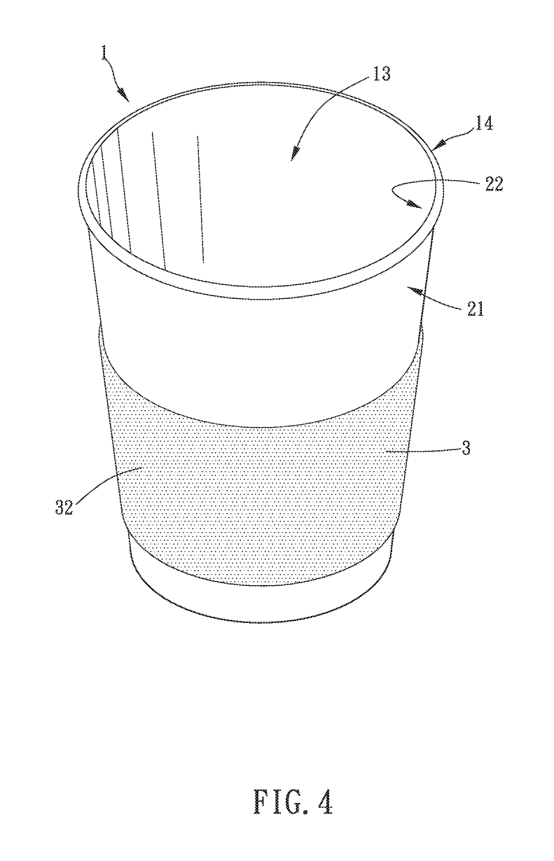

Please refer to FIGS. 1 to 4 for a first embodiment of the present invention. A method for manufacturing a paper container having a foamable layer includes following steps.

Please refer to step (a), a sheet material 2 is provided, the sheet material 2 has a first face 21 and a second face 22 opposite to the first face 21, and the sheet material 2 at least includes a paper layer 23. In this embodiment, the sheet material 2 only has one said paper layer 23, but in other embodiments, the sheet material 2 may have more than one said paper layer 23.

Please refer to step (b), an insulating layer 3 is coated at least partially on the first face 21 through screen printing to form a paper container substrate 24, the insulating layer 3 at least includes a foamable layer 32, the foamable layer 32 includes a waterborne acrylic resin part, foam powder and a waterborne additive part, the waterborne acrylic resin part and the waterborne additive part integrally form an insulating substrate 31, the foam powder is evenly distributed in the insulating substrate 31, and the foamable layer 32 has a foaming temperature.

It is to be noted that water-based, oil-based, resin-based, emulsion-based, or powder material and even coatings or adhesives can be used to screen print. Therefore, screen printing is an appropriate method for coating the insulating layer 3 on the first face 21. In addition, screen printing is conducted through scratching an object to be printed with a squeegee, and the squeegee is usually made of rubber so that the first face 21 receives less pressure and can be prevented from being damaged.

In this embodiment, the waterborne acrylic resin part accounts for 50 percent of the foamable layer 32 by weight, the foam powder accounts for 36 percent of the foamable layer 32 by weight, the waterborne additive part accounts for 12 percent of the foamable layer 32 by weight, and the foamable layer 32 further includes 2 percent of water by weight. In other embodiments, the waterborne acrylic resin part may account for 45 to 55 percent of the foamable layer 32 by weight, the foam powder may account for 31 to 41 percent of the foamable layer 32 by weight, the waterborne additive part may account for 10 to 14 percent of the foamable layer 32 by weight, and the foamable layer 32 may further include 1 to 3 percent of water by weight. A percentage of the waterborne acrylic resin part, the foam powder and the waterborne additive part of the foamable layer 32 may be adjusted according to various requirements.

Please refer to step (c), the paper container substrate 24 is manufactured into a paper container 1, the paper container 1 includes a body portion 11 and a bottom board 12 arranged at a bottom end of the body portion 11, the bottom board 12 and the body portion 11 define an accommodation space 13 and an opening 14 communicating with the accommodation space 13, the second face 22 faces toward the accommodation space 13, the insulating layer 3 is located on an outer circumferential face of the body portion 11 for a hand of the user to hold thereon, and in this embodiment, the insulating layer 3 surrounds the outer circumferential face of the body portion 11. Specifically, the paper container 1 in this embodiment is a cup, and in other embodiments, the paper container 1 may be a bowl, a to-go box or others.

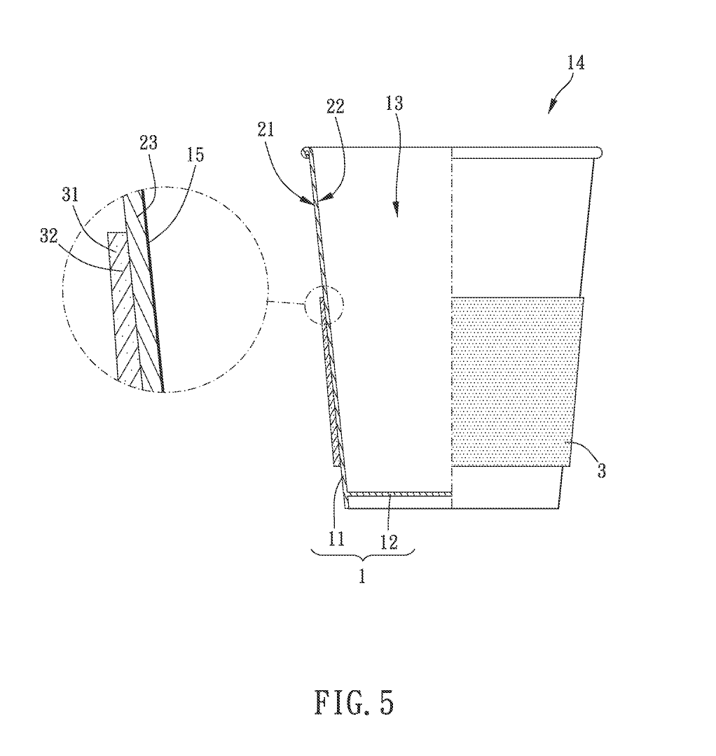

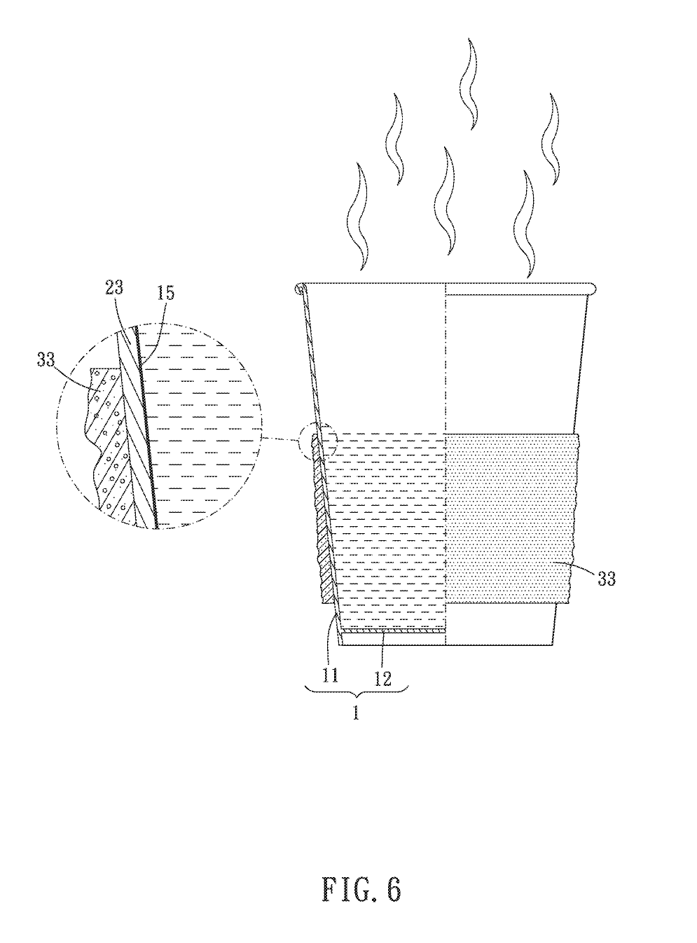

Please refer to FIGS. 5 and 6, preferably, an inner surface of the paper container 1 is further coated with a water-proof layer 15 to prevent liquid from leaking and prevent the paper container 1 from being broken due to wetness. In actual practice, when the paper container 1 contains a food or a liquid (in this embodiment, a liquid), and a temperature of the liquid is lower than the foaming temperature (the foaming temperature is approximately 80 to 100 degrees Celsius), the foamable layer 32 of the insulating layer 3 does not foam; when the temperature of the liquid equal to or higher than the foaming temperature, the foamable layer 32 starts to foam. After being foamed, the foamable layer 32 forms a foamed layer 33, and the foamed layer 33 has preferable insulating effect.

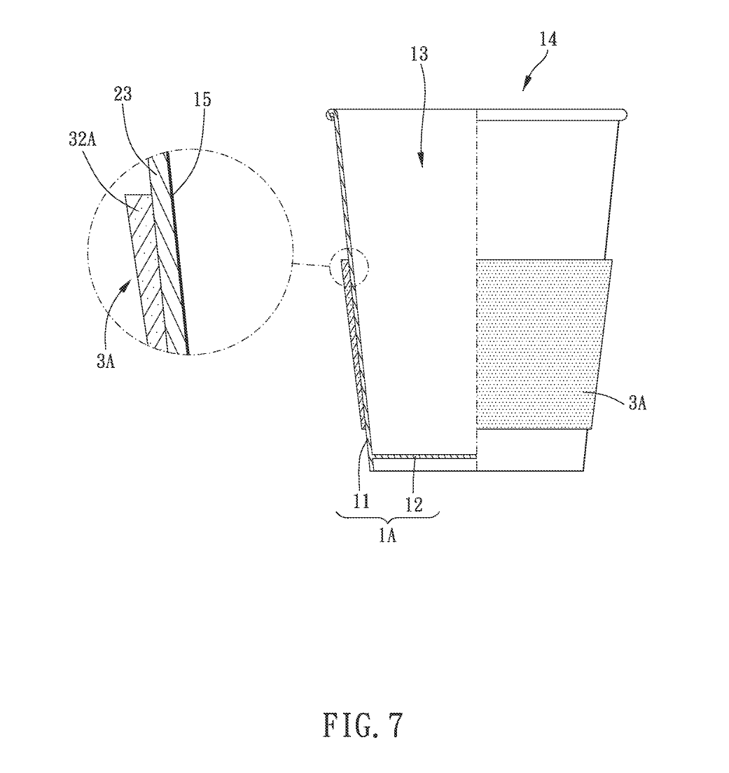

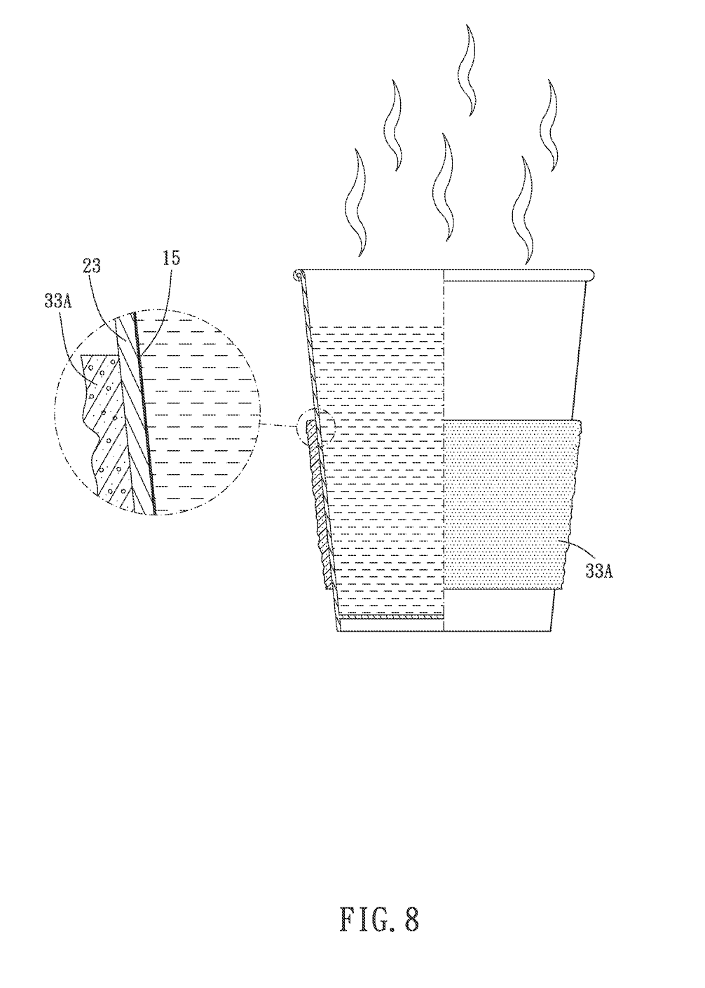

In this embodiment, the insulating layer 3 is gradually thickened from the opening 14 toward the bottom board 12. An insulating ability of the insulating layer 3 near the bottom board 12 is more preferable, so it is preferable to use the paper container 1 of this embodiment to contain the liquid in a high temperature and in less quantity. Please refer to FIGS. 7 and 8 for a second embodiment of the present invention. An insulating layer 3A is gradually thinned from the opening 14 toward the bottom board 12. An insulating ability of the insulating layer 3A near the opening 14 is more preferable, so it is preferable to use a paper container 1A of the second embodiment to contain the liquid in a high temperature and in more quantity. When the paper container 1A contains the liquid in a high temperature, a foamable layer 32A of the insulating layer 3A forms a foamed layer 33A, and the foamed layer 33A has preferable insulating effect. In addition, in other embodiments, the insulating layer may extend from the opening 14 toward the bottom board 12 in equal thickness.

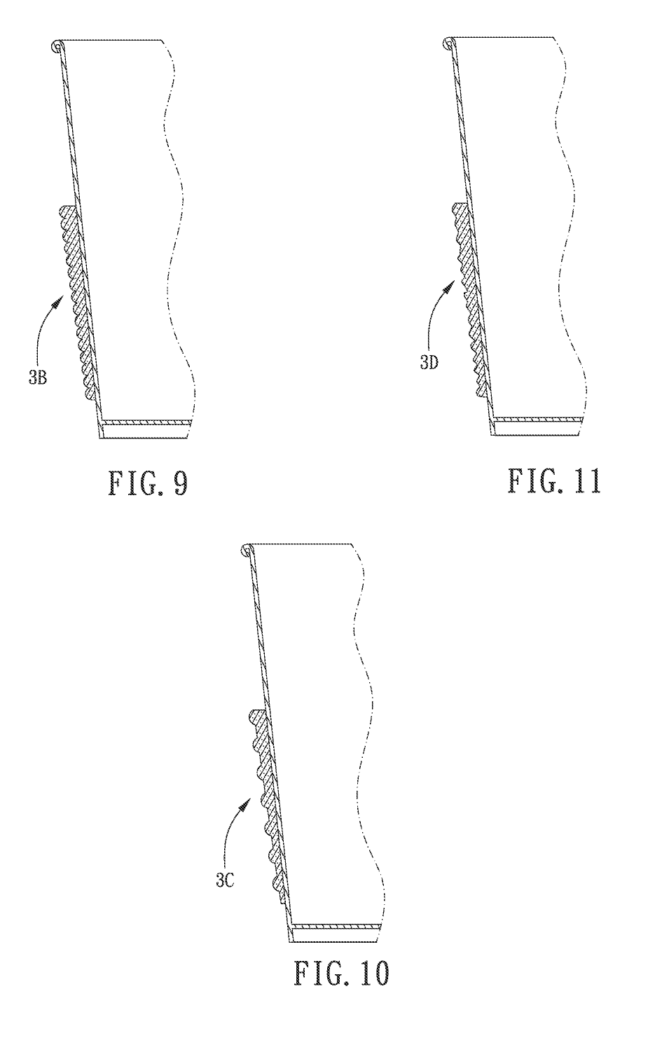

In addition, in the first and second embodiments, the outer surfaces of the insulating layers 3, 3A are plain so that it is more convenient to manufacture the insulating layers 3, 3A. Please refer to FIG. 9 for a third embodiment, a surface of the insulating layer 3B is formed in a continuously waved shape so that the user can hold the paper container firmly.

Please refer to FIG. 10 for a fourth embodiment. A surface of the insulating layer 3C is formed in an intervally waved shape, and a plurality of recesses in intervals on the surface of the insulating layer 3C are for fingers of the user to abut thereagainst so that it is more comfortable for the user to hold thereon firmly.

Please refer to FIG. 11 for a fifth embodiment. A surface of the insulating layer 3D is formed in an irregularly height-differentiated shape so that the insulating layer 3D provides greater friction and the user can hold the paper container firmly.

Given the above, the foaming temperature of the paper container of the present invention is low, so there is no need to heat the paper container to foam. When the paper container contains the food or liquid in a high temperature, the foamable layer is heated and starts to foam. After the foamable layer forms the foamed layer, the foamed layer has preferable insulating effect.

In addition, the insulating layer is at least partially spread on the first face through screen printing. Screen printing is conducted through scratching an object to be printed with a squeegee, and the squeegee is usually made of rubber so that the outer surface of the body portion receives less pressure and can be prevented from being damaged.

While we have shown and described various embodiments in accordance with the present invention, it should be clear to those skilled in the art that further embodiments may be made without departing from the scope of the present invention.

What is claimed is:

1. A method for manufacturing a paper container, including following steps of:
(a) providing a sheet material, the sheet material having a first face and a second face opposite to the first face and at least including a paper layer;
(b) coating an insulating layer at least partially on the first face through screen printing to form a paper container substrate, the insulating layer at least including a foamable layer, the foamable layer including a waterborne acrylic resin part, foam powder and a waterborne additive part, the waterborne acrylic resin part and the waterborne additive part integrally forming an insulating substrate, the foam powder being evenly distributed in the insulating substrate, the foamable layer having a foaming temperature;
(c) manufacturing the paper container substrate into the paper container, the paper container including a body portion and a bottom board disposed at a bottom end of the body portion, the bottom board and the body portion defining an accommodation space and an opening communicating with the accommodation space, the second face facing toward the accommodation space, the insulating layer being located on an outer circumferential face of the body portion.

2. The method for manufacturing a paper container having a foamable layer of claim 1, wherein in the step (b), the waterborne acrylic resin part accounts for 45 to 55 percent of the foamable layer by weight.

3. The method for manufacturing a paper container having a foamable layer of claim 1, wherein in the step (b), the foam powder accounts for 31 to 41 percent of the foamable layer by weight.

4. The method for manufacturing a paper container having a foamable layer of claim 1, wherein in the step (b), the waterborne additive part accounts for 10 to 14 percent of the foamable layer by weight.

5. The method for manufacturing a paper container having a foamable layer of claim 1, wherein in the step (b), the foamable layer further includes 1 to 3 percent of water by weight.

6. The method for manufacturing a paper container having a foamable layer of claim 1, wherein in the step (b), the waterborne acrylic resin part accounts for 50 percent of the foamable layer by weight, the foam powder accounts for 36 percent of the foamable layer by weight, the waterborne additive part accounts for 12 percent of the foamable layer by weight, and the foamable layer further includes 2 percent of water by weight.

7. The method for manufacturing a paper container having a foamable layer of claim 1, wherein in the step (c), an inner surface of the paper container is further coated with a water-proof layer.

8. The method for manufacturing a paper container having a foamable layer of claim 1, wherein in the step (c), the insulating layer is gradually thickened from the opening toward the bottom board.

9. The method for manufacturing a paper container having a foamable layer of claim 1, wherein in the step (c), the insulating layer is gradually thinned from the opening toward the bottom board.

10. The method for manufacturing a paper container having a foamable layer of claim 1, wherein in the step (c), a surface of the insulating layer is formed in a continuously waved shape.

11. The method for manufacturing a paper container having a foamable layer of claim 1, wherein in the step (c), a surface of the insulating layer is formed in an intervally waved shape.

12. The method for manufacturing a paper container having a foamable layer of claim 1, wherein in the step (c), a surface of the insulating layer is formed in an irregularly height-differentiated shape.
